(19) United States
(12) Patent Application Publication
(10) Pub. No.: US 2008/0217380 A1
(43) Pub. Date: Sep. 11, 2008

(54) Method and apparatus to relieve residual stress or distortion in a heat processed article

(75) Inventors: David Y. Chua, Carver, MN (US); James L. Freeman, Bloomington, MN (US)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: MTS Systems Corporation, Eden Prairie, MN (US)

(21) Appl. No.: 11/714,069

(22) Filed: Mar. 5, 2007

(51) Int. Cl. B23K 28/00; B23Q 15/007

(52) U.S. Cl. 228/176; 228/18; 228/8

(57) ABSTRACT

The application discloses a method and apparatus to apply pressure to a heated or weld region of a workpiece to relieve residual stress and distortion. In illustrated embodiments, heat is supplied via a probe that traverses a workpiece to heat a region of the workpiece. Pressure is applied to the heated region following the application of heat. In illustrated embodiments, pressure is supplied via a roller assembly, which is configured to traverse the workpiece to apply pressure to the heated or weld regions.

### BACKGROUND

The discussion below is merely provided for general background information and is not intended to be used as an aid in determining the scope of the claimed subject matter.

Material processing techniques or applications utilize a heat source to heat a region of a workpiece or material, such as metal. Such processing techniques for example, include friction stir welding, linear friction welding, laser welding, Tungsten Inert Gas (“TIG”) welding, Metal Inert Gas (“MiG”) welding, arc welding, friction stir processing and other processing techniques. Friction stir welding and friction stir processing uses a rotating probe which generates frictional heat via the applied pressure to a region of the workpiece while stirring the material in a plastic state. In friction stir welding, the rotating probe is used to generate heat and stir the material to form a weld region joining multiple workpiece portions. In friction stir processing, the rotating probe generate heats and stirs the material to modify or control properties of the workpiece in the process region of the workpiece or material. The application of heat and pressure during friction stir welding, friction stir processing and other process or welding techniques can introduce residual stress and distortion to the workpiece or workpiece portions. Surface disruptions (or lack of smoothness) can also develop from any of the techniques described above. Such distortion or residual stress along with any surface disruptions is typically not desired and can lead to crack propagation and/or degradation of the material or weld connection. The present invention addresses these and other problems.

### SUMMARY

The Summary and Abstract are provided to introduce a selection of concepts in a simplified form that are further described below in the Detailed Description. The Summary and Abstract are not intended to identify key features or essential features of the claimed subject matter, nor are they intended to be used as an aid in determining the scope of the claimed subject matter. In addition, the claimed subject matter is not limited to implementations that solve any or all disadvantages noted in the background.

Embodiments of the application disclose methods and apparatus configured to apply pressure to a heated or weld region of a workpiece to relieve residual stress and distortion. In illustrated embodiments, heat is supplied via a probe that traverses a workpiece to heat a region of the workpiece. Pressure is applied to the heated or weld region following the application of heat. In illustrated embodiments, pressure is applied via a device such as a roller assembly, which is configured to traverse the workpiece to apply pressure to the heated regions. The roller assembly can be removably coupled to an assembly tool or probe to supply heat in a first pass and apply pressure in a second pass.

### BRIEF DESCRIPTION OF THE DRAWINGS

FIG. 1 is a schematic illustration of a process assembly including a heat source to apply heat to a workpiece.

FIG. 2 is schematic illustration of a pressure assembly to relieve stress in a heat processed workpiece or article.

FIG. 3 is a flow chart illustrating steps for processing a workpiece or article.

FIG. 4 schematically illustrates a heat or welding probe to weld a first workpiece portion to a second workpiece portion.

FIG. 5 is a schematic illustration of a pressure assembly to relieve stress along a weld region joining multiple workpiece portions.

FIG. 6 is a flow chart illustrating processing steps for welding multiple workpieces.

FIG. 7 is a schematic illustration of a pressure application device including a roller assembly to apply pressure to a heated region of a workpiece.

FIGS. 8-10 illustrate an embodiment of a pressure application device including a roller assembly to apply pressure to a heated region of a workpiece.

FIG. 11 illustrates the pressure application device of FIGS. 8-10 having a shifted position to self align the roller assembly relative to a workpiece surface.

FIGS. 12-14 illustrate an alternate embodiment of a pressure application device.

FIG. 15 is a flow chart illustrating processing steps including supplying heat and pressure to a workpiece or workpiece portions in multiple process passes.

FIG. 16 is a schematic illustration of an embodiment of an assembly tool including a removable pressure application device.

FIG. 17 is a flow chart illustrating processing steps for a heat processed workpiece or article of an illustrative embodiment.

FIG. 18 is a schematic illustration of an assembly tool including a heat probe and pressure application device.

### DETAILED DESCRIPTION OF ILLUSTRATIVE EMBODIMENTS

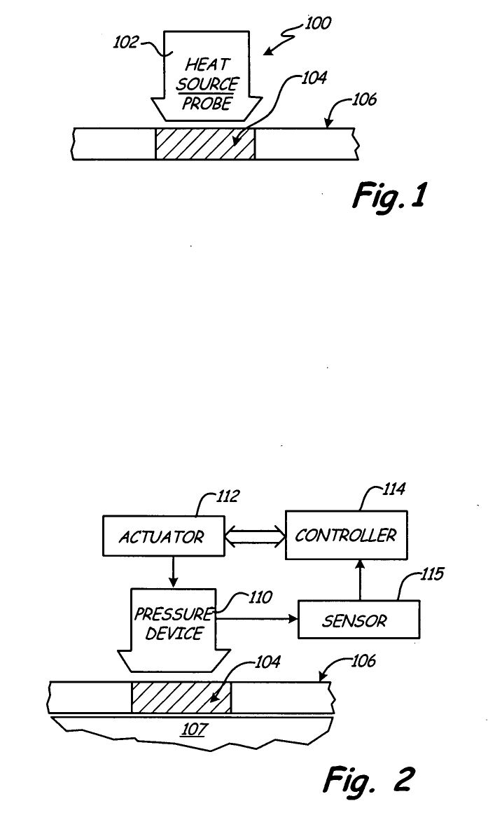

FIG. 1 schematically shows a process assembly 100 including a heat source or probe 102 configured to heat a region 104 of a workpiece or workpieces 106. Following the application of heat, region 104 cools. The application of heat and cooling that follows can introduce residual stress and distortion to the material or workpiece 106.

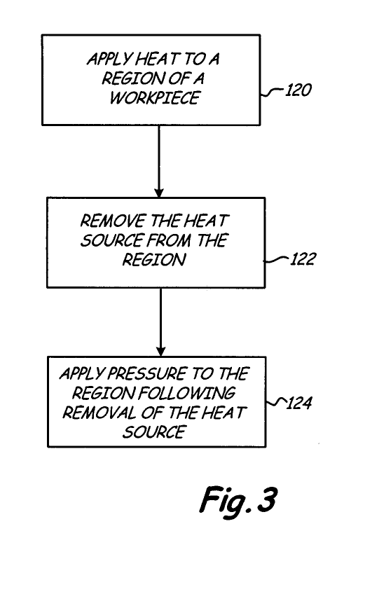

FIG. 2 schematically illustrates an embodiment of a pressure application device 110 that applies pressure to the heated region 104 of the workpiece 106 (for example, an aluminum or aluminum alloy workpiece) against a reaction structure or support 107 to minimize stress and distortion. Pressure is applied through the pressure application device 110 via operation of a load or actuator device 112 under operation of controller 114. The pressure applied to the workpiece 106 is a function of the load force supplied from actuator 112, configuration of the pressure application device 110 and the reaction structure or illustrated embodiment, the controller 114 is programmed to provide a set point load, the magnitude of which is based upon the configuration and size of the pressure application device 110 and properties of the workpiece 106. The actuator 112 is operated via controller 114 based upon feedback from sensor 115 which illustratively is a load or position sensor or both to provide load and/or position control. Although an example workpiece material is disclosed, embodiments of the present application can be used with various metals or other materials and application is not limited to a particular workpiece material.

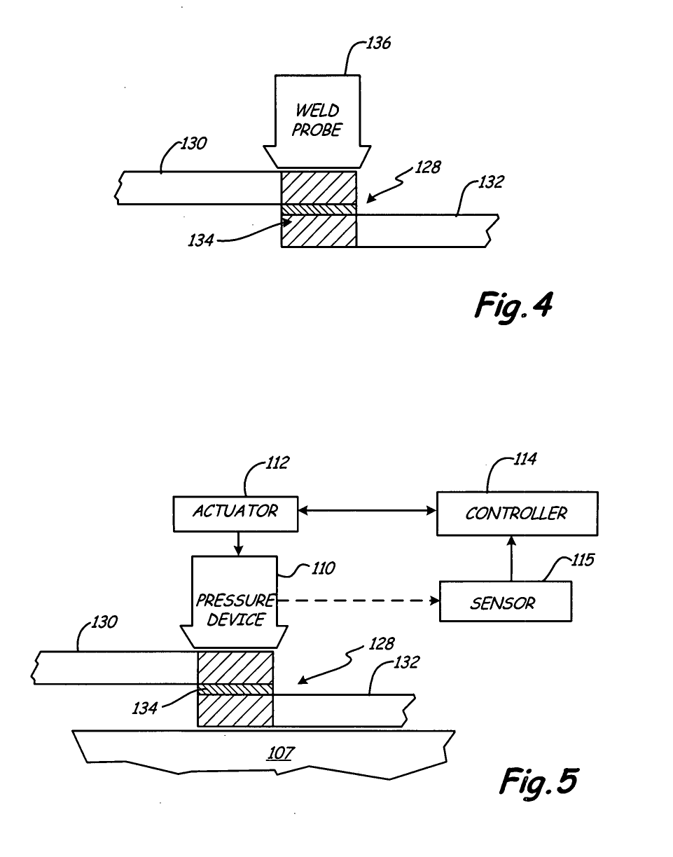

FIG. 3 is a flow chart illustrating process steps for an exemplary embodiment of the present invention. As shown in step 120, heat is applied to a region 104 of the workpiece 106. For example, a region of the workpiece 106 is heated in association with a welding or other process application. In step 122, the heat source 102 is removed from the heated region 104 of the workpiece 106. Following removal of the heat source 102 from the region 104, pressure is applied via the pressure application device 110 in step 124 to relieve residual stresses and distortion of the workpiece or material.

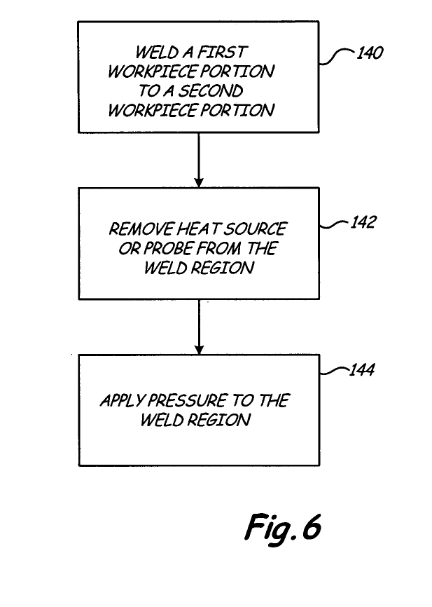

Welding applications utilize heat to join multiple workpiece portions to form a weldment. Welding processes can be used to connect or join parts such as rolled plates, sheets, shapes, pipes, castings, forgings, billets or other structures to produce the weldment. The parts or workpiece portions can be joined using different joints, such as a butt joint, lap joint, edge joint or other joints as will be appreciated by those skilled in the art. FIG. 4 illustrates a weldment 128 connecting a first portion 130 to a second portion 132 along a weld region 134. As shown in FIG. 4, the weld region 134 is formed via the application of heat and pressure from a welding probe 136. Illustratively, the welding probe 136 can be an electrode, a rotating probe, a reciprocating probe or a magnetic probe and application is not limited to a particular welding probe nor the particular welding joint illustrated in FIG. 4.

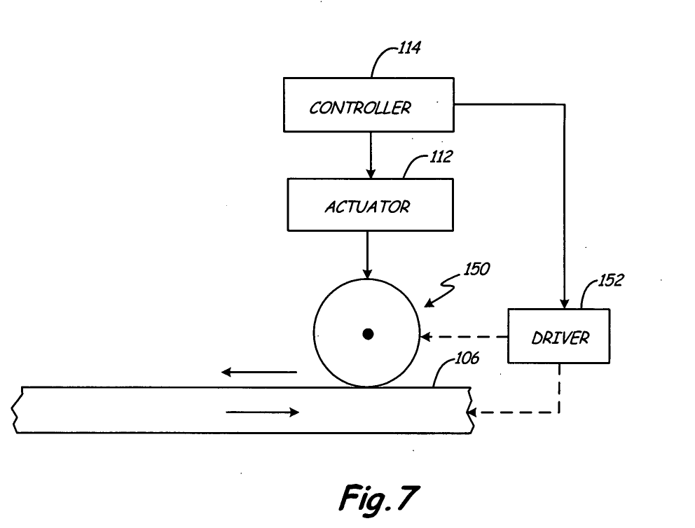

As schematically shown in FIG. 5, pressure is applied to the weld region 134 against a reaction structure or support 107 to minimize stress and distortion in the weld region 134. Pressure is applied via the pressure application device 110 based upon a load force supplied from actuator 112. The actuator 112 is operated via controller 114 based upon feedback from sensor 115 which illustratively is a load and/or position sensor to provide load or position control or both.

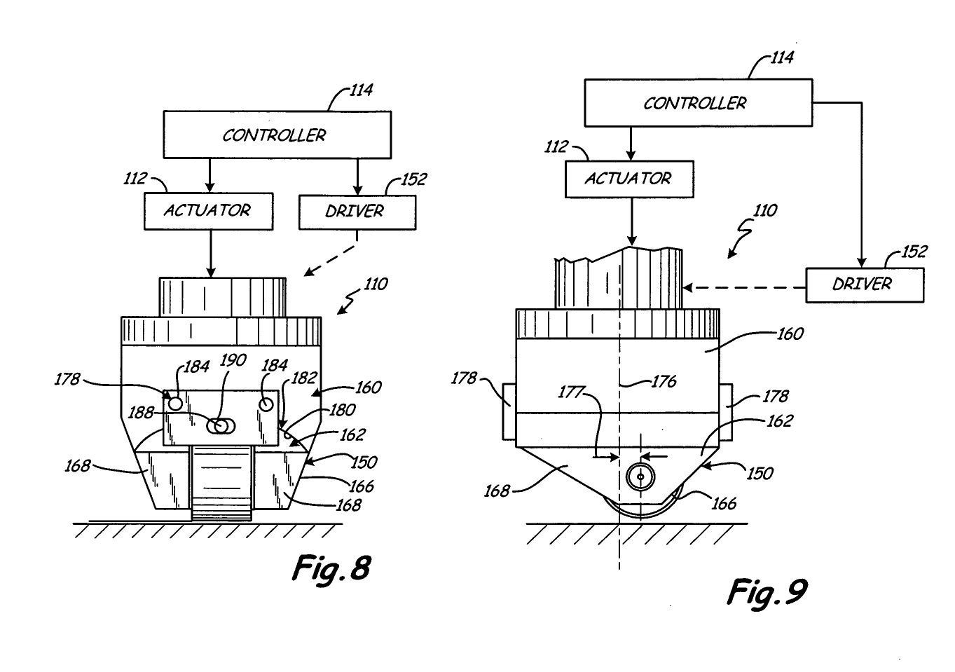

FIG. 6 is a flow chart illustrating process steps for the illustrative embodiment shown in FIGS. 4-5. In step 140, a first workpiece portion is welded to a second workpiece portion via application of heat and pressure from a weld probe 136. Illustratively, the welding probe 136 traverses the workpiece to weld the first workpiece portion to the second workpiece portion. The application of pressure, heating and cooling or deformation of the material during the welding process can introduce residual stress in the workpiece. In step 142, the heat source (or weld probe 136) is removed and in step 144, pressure is applied to the weld region 134 to relieve residual stress and minimize distortion. Thus in illustrated embodiments, pressure is applied to the heated region of the workpiece following the application of heat and pressure.

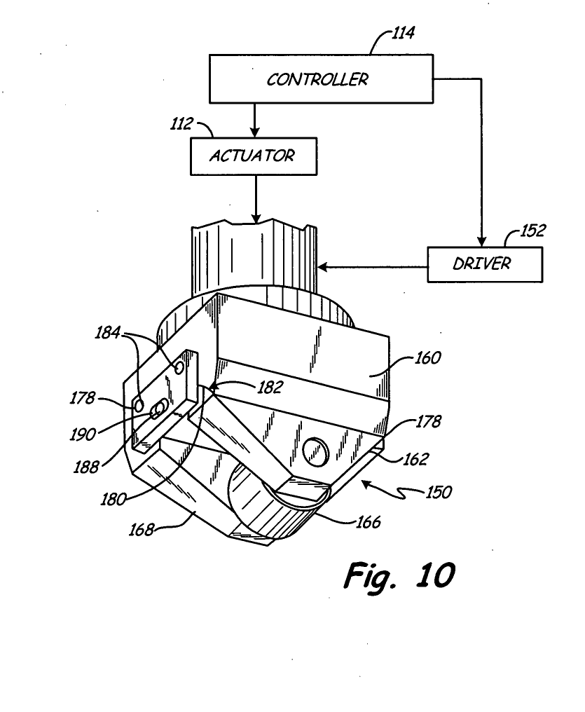

FIG. 7 illustrates an embodiment of a pressure application device 110 to apply pressure as described in FIGS. 1-6 where like numbers are used to refer to like parts in the previous FIGS. In the illustrated embodiment of FIG. 7, the pressure application device includes a roller assembly 150 (illustrated schematically) which is biased towards the workpiece surface via a load force supplied by actuator 112. A driver 152 is coupled to the roller assembly 150 or workpiece 106 to move the roller assembly 150 or workpiece 106 to traverse the roller assembly 150 relative to the workpiece to apply pressure to the heated or weld region.

For example in an illustrated embodiment, the driver 152 is coupled to the roller assembly 150 to move the roller assembly 150 along a travel axis or path to continuously supply pressure to the weld or heated region of the workpiece 106. Alternatively, the driver 152 is coupled to the workpiece 106 to traverse the roller assembly 150 relative to the workpiece 106 to apply pressure to the weld or heated region. Thus, either the workpiece 106 or the roller assembly 150 can be moved to traverse the workpiece to apply pressure to heated regions of the workpiece 106. The travel axis or path of the roller assembly 150 or workpiece 106 can be along a single travel axis or multiple axes or directions.

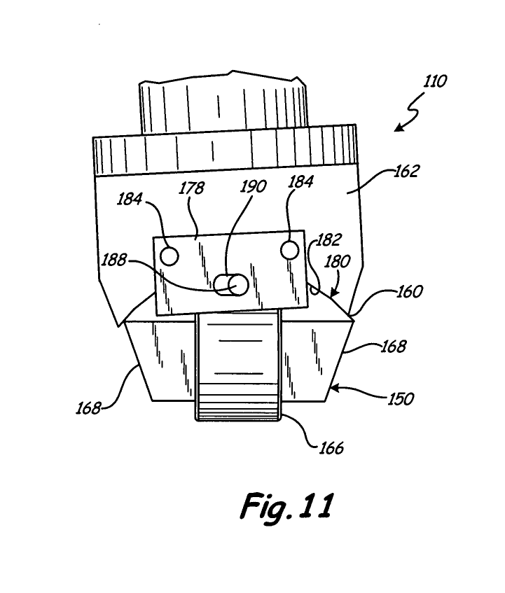

FIGS. 8-10 illustrate an embodiment of a pressure application device 110 that applies pressure. As shown, the pressure application device 110 includes a first body portion 160, a second body portion 162 and the roller assembly 150. In the illustrated embodiment, the roller assembly 150 includes a roller drum 166 rotationally coupled to spaced roller support plates 168 extending from the second body portion 162. In an illustrated example, the roller drum 166 is formed of hardened steel for application of relatively high loads. It should be understood that other drum materials can be used depending upon the workpiece and application process.

In illustrated embodiments, the roller drum 166 includes a relatively flat roller surface having a relatively smooth surface texture to provide a relatively even load across a width of the roller drum 166. Although the particular roller drum 166 shown includes a flat contour, application is not limited to a roller drum having a flat surface contour or relatively smooth surface texture as shown. For example, in alternate embodiments, the outer surface of the roller drum can be curved (i.e. having different radii from the axis of rotation) and/or other surface textures depending upon the workpiece material and particular application.

In the embodiment shown, the actuator 112 is coupled to the first body portion 160 to supply a load force to the roller drum 166 through the second body portion 162. Illustratively, the actuator 112 is a pneumatic or hydraulic cylinder that is configured to supply sufficient load force to the roller drum 166. As shown, the load actuator 112 is coupled to controller 114 for operation. In illustrated embodiments, the controller 114 includes a load control algorithm or mode to maintain a set point or input load force based upon feedback from a load sensor. The set point load force depends upon the configuration and size of the roller as well as other parameters such as the workpiece material.

In an illustrative example, the set point load force supplied via the actuator 112 is approximately 1,000-2,000 lbs. Although a particular range is provided, application of the present invention is not limited to the particular magnitude or load control disclosed. For example, the controller 114 can use a position control algorithm to control actuator parameters based upon feedback from a position sensor or both load and position control.

In an illustrated embodiment, the driver 152 is coupled to roller assembly to move the assembly along the travel axis or path. Movement of the device along the travel axis or path rotates the roller drum 166 to continuously apply pressure to the workpiece surface. Illustratively, the driver 152 includes a mechanized assembly that moves the pressure application device or roller assembly along the travel axis or path as appreciated by those skilled in the art. As previously described in an alternate embodiment, the workpiece is moved along a travel axis or path to provide relative movement between the workpiece and the roller drum 166.

In the embodiment shown in FIGS. 8-10, the load force is supplied to the pressure application device and roller assembly along a load axis 176 as shown in FIG. 9. As shown, the roller drum 166 is rotationally coupled to the second body portion 162 at a location laterally spaced from the load axis 176 so that the roller is spaced from or behind the load axis 176 a distance 177. Placement of the roller a distance from the load axis 176 provides directional stability and facilitates steering so that the roller assembly follows the travel path of the driver 152.

As previously described, the roller drum 166 is rotationally coupled to the spaced roller support plates 168 extending from the second body portion 162. The second body portion 162 can be floatably coupled to the first body portion 160 via float plates 178 coupled to opposed ends of the first and second body portions 160, 162. As shown in FIG. 8, the second body portion 162 includes a rounded or convex surface 180 which mates with a concave surface 182 of the first body portion 160. Float plates 178 are fixedly connected to the first body portion 160 via openings 184. The second body portion 162 is connected to the float plates 178 via pins 188 movable along an elongate slot 190 of the float plates 178.

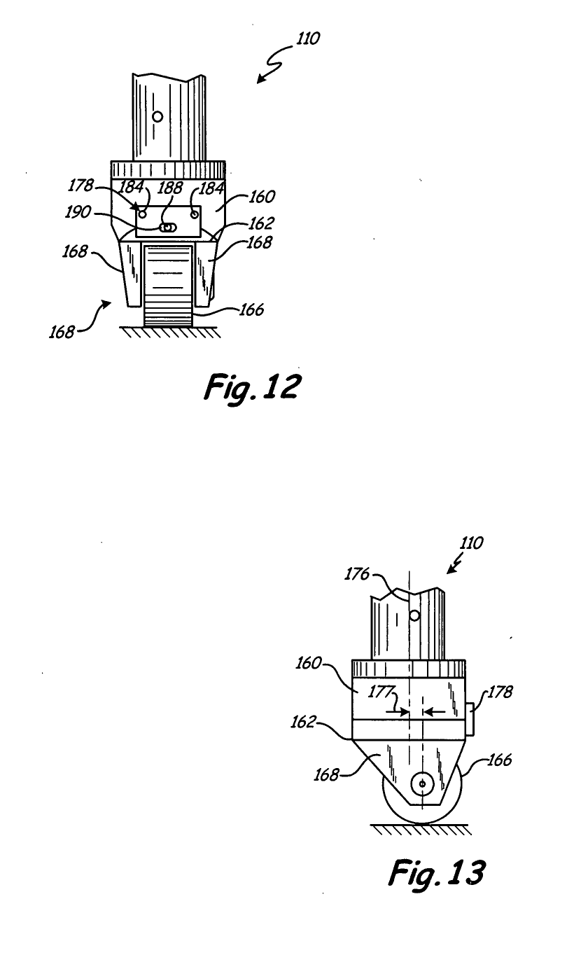

The illustrated connection of the second body portion 162 to the first body portion 160 allows the orientation of second body portion 162 and roller assembly to shift along the concave surface 180 of the first body portion 160 to self align the drum surface relative to the workpiece surface as shown in FIG. 11. Although the float connection shown is limited to transverse movement between the first and second body portions 160, 162, application is not limited to the particular connection shown and alternate floatable connections can be used with one or more degrees of freedom.

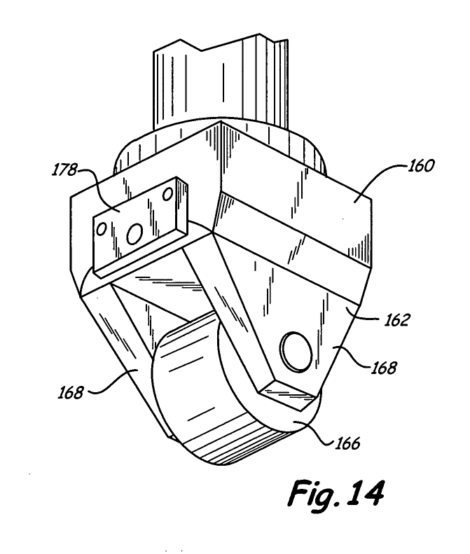

FIGS. 12-14 illustrate another embodiment of a pressure application device 110 including a roller assembly where like numbers are used to identify like parts in the previous FIGS. The pressure application device illustrated in FIGS. 12-14 is similar to the device shown in FIGS. 8-10. As shown the pressure application device 110 includes a roller assembly having a roller drum 166 coupled to spaced roller support plates 168 extending from the second body portion 162. The load force is supplied via actuator (not shown in FIGS. 12-14) to the second body portion 162 through the first body portion 160 along axis 176 as previously described.

In the embodiment illustrated in FIGS. 12-14, the second body portion 162 is coupled to the first body portion 160 via a single float plate 178. Float plate 178 allows a position of the second body portion 162 to shift relative to the first body portion 160 so that the roller assembly follows the weld contour. As shown, the size and contour of the roller drum 166 in FIGS. 12-14 is different from the embodiment illustrated in FIGS. 8-10. Illustratively, a cross width dimension of the roller drum 166 of the embodiment illustrated in FIGS. 8-10 is wider than the cross width of the roller drum 166 of FIGS. 12-14. The cross width of the roller drum 166 can vary depending upon the width of the heated or weld region and illustratively is designed to simultaneously apply pressure across the width of the heated or weld region. The illustrated pressure application device can also have different roller drum diameters depending upon the desired pressure and the particular load and width of the roller drum 166 as will be appreciated by those skilled in the art.

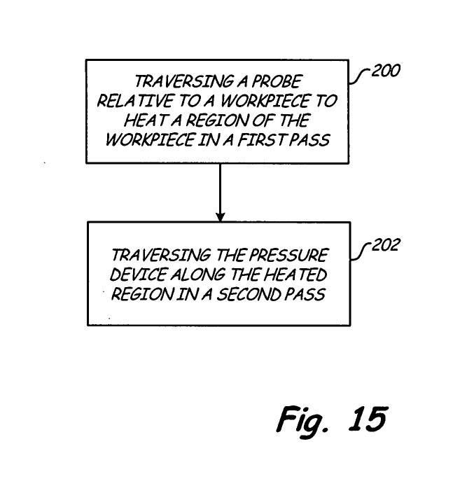

As previously described, the pressure application device is used to relieve residual stress following the application of heat and/or pressure to an article or workpiece from a heat source or probe. FIG. 15 illustrates a process application including multiple travel passes along the workpiece 106 to heat and apply pressure to a workpiece 106. As shown in step 200, a region of the workpiece or workpiece portions is heated by traversing a probe or other heat source relative to the workpiece in a first pass. Illustratively, the heat probe is moved along a length or dimension of the workpiece to heat a region along the length or dimension of the workpiece in the first pass. Alternatively, the workpiece is moved relative to the heat source or probe in the first pass. In step 202, pressure is applied to the heated region by traversing the pressure application device along a length of the heated region in a second pass. Similarly, either the pressure application device 110 or workpiece 106 is moved to apply pressure to the heated region in the second pass.

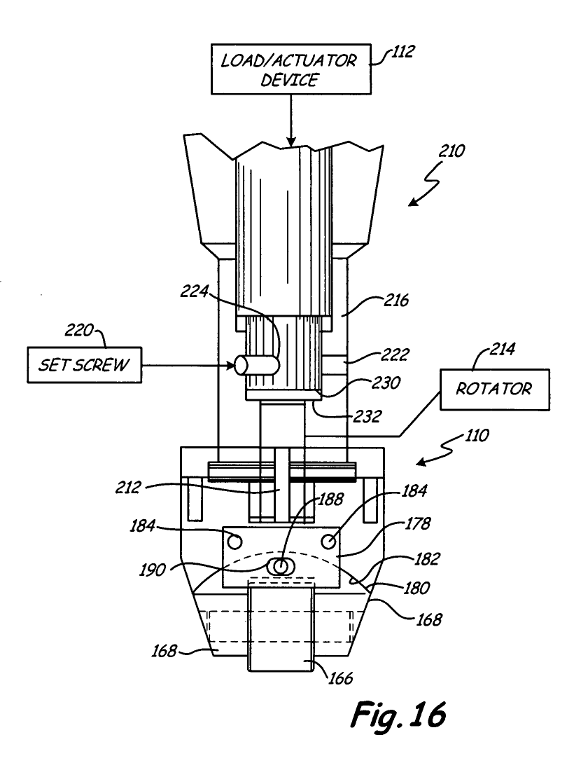

FIG. 16 illustrates an embodiment of an assembly tool 210 including a pressure application device 110 removably coupled to the assembly tool 210 to sequentially supply heat in a first pass and supply pressure in a second pass. As shown, the assembly tool includes a heat probe which in the illustrated embodiment, is a rotating probe 212. The probe 212 is rotated via rotator mechanism 214 to generate heat to process or weld a workpiece or portions while a load is supplied to the probe via the load actuator 112. In alternate embodiments the heat probe can be a reciprocating probe, electrode, and other heat or welding probe and application is not limited to a particular probe. It should be understood that the heat probe is not limited to a contact probe and other non-contact probes can be used to generate heat in the heated region.

In FIG. 16, the pressure application device 110 is connected to the assembly tool 210 to supply pressure following the application of heat via the rotating or heat probe. As previously described the pressure application device 110 traverses the heated region via operation of driver (not shown in FIG. 16). In the illustrated embodiment, the same driver can be used to move both probe 212 and pressure application device 110 or alternatively, the driver can move the workpiece or workpieces 106.

In the embodiment illustrated in FIG. 16, the pressure application device includes a roller assembly, which is coupled to the assembly tool 210 via an elongate sleeve 216 that extends from a body portion of the pressure application device 110. The elongate sleeve 216 is sized to slide over the rotating probe 212 and is secured to the assembly tool 210 via a set screw 220 which extends through a transverse opening 222 of the sleeve 216 and through a transverse opening 224 of the tool 210. When connected, the actuator device 112 supplies a load force to the roller assembly through an interface between an outer shoulder 230 on the tool 210 and an inner shoulder 232 of the sleeve 216. This construction is particularly convenient to use since the probe 212 does not need to be removed to install the pressure application device 210.

It should be appreciated that although FIG. 16 illustrates a particular removable connection and probe, application is not limited to the particular embodiment shown and other connections can be used to removably connect the pressure application device to a rotating or other heat probe.

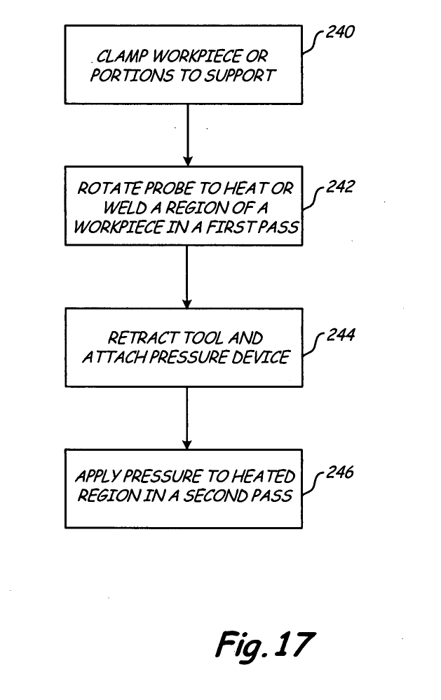

FIG. 17 illustrates steps for processing an article via an assembly tool 210 having a pressure application device removably coupled to the assembly tool 210 as illustrated in FIG. 16. In step 240, the workpiece is clamped to a support. In step 242, the assembly tool is lowered, the probe is rotated and either the probe or the workpiece is moved to heat a region of the workpiece in a first pass. Alternatively, in step 242 a non-rotating probe can be energized to heat or weld a region of the workpiece in the first pass. In step 244, the tool 210 is retracted from the workpiece and the pressure application device 110 is attached to the tool 210. Thereafter in step 246, a load force is applied to the pressure application device 110 and the pressure application device or workpiece is moved to apply pressure to the heated region of the workpiece in the second pass. It should be noted that the same controller can be used for both the probe and pressure application device. If desired, a sensor can be provided to automatically detect the presence of pressure application device 210 and make any necessary accommodations to the travel path. In illustrated embodiments, the travel path of the first and second passes can be the same travel path or in opposite directions.

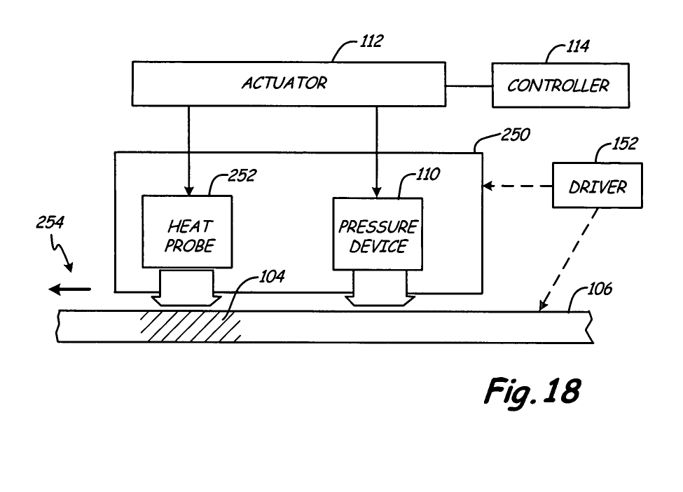

In an alternate embodiment, the heat probe and pressure application device traverse the workpiece to form a heated region and to supply pressure to the heated region in a single pass. FIG. 18 illustrates an assembly tool 250 including a heat or welding probe 252 and pressure application device 110 (illustrated schematically) that are configured to sequentially heat and pressurize the workpiece along the travel path illustrated by arrow 254. In an illustrated embodiment, the heat or welding probe 252 is a rotating probe that is biased towards the workpiece surface via actuator 112 to generate heat.

The pressure application device 110 is spaced from the probe 252 to provide pressure to the heated region following removal of the probe 252 from the heated region. The pressure application device is spaced from the probe 252 so that the application of pressure follows removal of the heat source or probe 252. Pressure is supplied to the workpiece surface via application of force from the actuator 112 under operation of controller 114. The controller 114 can be configured to operate the actuator 112 to maintain a set point load based upon force feedback and/or can operate the actuator 112 to maintain a position set point based upon position feedback to provide position control. For example, force feedback can be provided via feedback pressure in an actuator cylinder of a pneumatic or hydraulic actuator 112.

Application of pressure to the heated or weld region is not limited to the roller assembly illustrated in FIGS. 7-14 and FIG. 16. For example, pressure can be applied via a pressure plate (not shown) having a load force or bias imparted via actuator 112.

Although the subject matter has been described in language specific to structural features and/or methodological acts, it is to be understood that the subject matter defined in the appended claims is not limited to the specific features or acts described above as has been held by the courts. Rather, the specific features and acts described above are disclosed as example forms of implementing the claims.

What is claimed is:

1. A method comprising:
heating a region of a workpiece;
removing a heat source from the heated region of the workpiece; and
biasing a pressure application device towards the heated region of the workpiece and applying pressure to the heated region of the workpiece following removal of the heat source.

2. The method of claim 1 wherein the step of heating the region of the workpiece comprises:
supplying a load force to a rotating probe; and
rotating the probe in the workpiece.

3. The method of claim 2 and further comprising:
clamping the workpiece to a support; and
traversing the rotating probe along the workpiece to generate the heated region.

4. The method of claim 1 wherein the step of driving the pressure application device and applying pressure comprises:
supplying a load force to a roller assembly; and
traversing the roller assembly along the heated region.

5. The method of claim 4 and comprising:
traversing a heat probe along the workpiece in a first pass to form the heated region; and
traversing the roller assembly along the heated region in a second pass to supply pressure to the heated region.

6. The method of claim 1 and further comprising:
applying a load force to the pressure application device to supply pressure to the heated region.

7. The method of claim 6 and further comprising:
receiving load feedback; and
controlling the load force to the pressure application device based upon the load feedback.

8. The method of claim 1 wherein the steps of heating and applying pressure comprise:
traversing the workpiece with a welding probe to weld a first workpiece portion to a second workpiece portion; and
applying pressure to the weld region connecting the first workpiece portion to the second workpiece portion via the pressure application device separate from the welding probe.

9. The method claim 1 wherein the pressure application device includes a cross width having a dimension to supply simultaneous pressure across a width of the heated region.

10. A method comprising:
traversing a heat probe along a workpiece in a first pass to heat a region of the workpiece; and
traversing a pressure application device along the workpiece in a second pass to supply pressure to the heated region of the workpiece.

11. The method of claim 10 wherein the heat probe forms a welding probe and further comprising:
welding a first workpiece portion to a second workpiece portion to joint the first workpiece portion to the second workpiece portion along a weld region in the first pass;
and
traversing the pressure application device along the weld region in the second pass.

12. The method of claim 10 wherein the heat probe is a rotating probe and further comprising:
supplying a load force to the rotating probe; and
rotating the probe relative to the workpiece to heat the region of the workpiece.

13. The method of claim 10 wherein the heat probe forms a portion of an assembly tool and further comprising:
retracting the heat probe from the workpiece; and
removably attaching the pressure application device to the assembly tool to supply pressure in the second pass.

14. The method of claim 10 wherein the pressure application device includes a roller assembly and further comprising:
applying a load force to a roller assembly; and
traversing the roller assembly relative to the workpiece in the second pass.

15. An assembly comprising:
an assembly tool including a heat probe configured to supply heat to a workpiece;
a pressure application device configured to supply pressure to the workpiece separate from the heat probe; and
an actuator device coupled to the pressure application device and configured to supply a load force to the pressure application device.

16. The assembly of claim 15 wherein the actuator device is coupled to the heat probe and configured to supply a load force to the heat probe.

17. The assembly of claim 15 and comprising:
a sensor; and
a controller configured to receive feedback from the sensor and control the actuator device based upon the feedback.

18. The assembly of claim 17 wherein the sensor is at least one of a position sensor or a load sensor.

19. The assembly of claim 15 wherein the pressure application device is removably coupleable to the assembly tool.

20. The assembly of claim 15 wherein the heat probe comprises;
a rotating probe; and
a rotator coupled to the rotating probe to rotate the probe to supply heat to the workpiece.

21. The assembly of claim 20 wherein the pressure application device is removably coupleable to the rotating probe.

22. The assembly of claim 15 wherein the pressure application device includes an elongate sleeve extending from a body portion of the pressure application device and the elongate sleeve is configured to slide over a portion of the heat probe to removably connect the pressure application device to the assembly tool.

23. The assembly of claim 15 wherein the pressure application device is removable coupled to the assembly tool via a set screw.

24. The assembly of claim 15 wherein the pressure application device includes a roller assembly and the roller assembly is removable coupled to the assembly tool.

25. The assembly of claim 15 wherein the pressure application device includes a roller assembly and the actuator device is configured to supply a load force along a force axis aligned with the heat probe and the roller assembly includes a roller drum rotatable about an axis spaced from or off-axis from the force axis of the actuator device.

26. The assembly of claim 15 wherein the pressure application device includes a first body portion coupled to the actuator device and a second body portion having a roller assembly coupled thereto and the first and second body portions are floatable connected to allow an alignment of the second body portion to shift relative to the first body portion.

27. A method comprising
moving a heat probe along a workpiece to heat a region of the workpiece; and
biasing a pressure application device toward the heated region of the workpiece to supply pressure across a width of the heated region of the workpiece following withdrawal of the heat probe from the heated region of the workpiece.

28. The method of claim 27 wherein the pressure application device simultaneously supplies pressure across the width of the heated region.

29. The method of claim 27 and comprising:
moving the pressure application device along a length of the workpiece.
